(19) United States
(12) Patent Application Publication
(10) Pub. No.: US 2005/0050103 A1
(43) Pub. Date: Mar. 3, 2005

(54) Displaying and presenting multiple media streams from multiple DVD sets

(75) Inventors: Lawrence Kesteloot, San Francisco, CA (US); Paul Rechsteiner, Toronto (CA); Michael A. Malcolm, Aspen, CO (US); Stephen Watson, Toronto (CA)

Correspondence Address: SWERNOFSKY LAW GROUP PC, P.O. BOX 390013, MOUNTAIN VIEW, CA, 94039-0013, US

(73) Assignee: Kaleidescape, Mountain View, CA (US)

(21) Appl. No.: 10/932,330

(22) Filed: Aug. 31, 2004

Related U.S. Application Data
(63) Continuation-in-part of application No. 10/655,496, filed on Sep. 3, 2003.
(60) Provisional application No. 60/488,367, filed on Jul. 15, 2003.

(51) Int. Cl. G06F 17/00

(52) U.S. Cl. 707/104.1

(57) ABSTRACT

Associating multiple content chunks with multiple DVD packages or media objects; conveniently viewing or resuming these content chunks without knowing their disposition. Associating content chunks with media objects and positions therein, associating requests by a user for play or resumption of play with appropriate behaviors, including a database. Media objects have unique media hash values, to associate content chunks with hash values, and positions within media objects maintained by bookmarks and watchpoints. Selecting a content chunk might cause its metadata to be presented, or might cause selectable content chunks within that content chunk to become selectable. Users requesting play or resumption of play of content chunks, might cause those content chunks, or might cause smaller content chunks, such as movies, to be presented. Content chunks might span more than one media object, or might switch back and forth among multiple media objects, each without the viewer needing to know.

### BACKGROUND OF THE INVENTION

1. Field of the Invention

The invention relates to associating multiple media streams (possibly found in packages containing multiple DVDs), with their disposition within such packages, with the effect of allowing a user to conveniently and naturally select those media streams, and present or resume presentation of those media streams, or an appropriate media stream thereof, without the user needing to know the disposition of those media streams within those packages.

For an example, not intending any limit to the generality of the invention, in one embodiment, a single DVD might include multiple selectable content chunks for presentation, of which the user conveniently and naturally selects and views their choice thereof.

For an example, not intending any limit to the generality of the invention, in one embodiment, a DVD package containing multiple discs might collectively include a single selectable content chunk for presentation, which the user conveniently and naturally selects and views as a unit.

2. Related Art

When DVDs are created, they might have more than one media stream written onto the physical media. This can occur in one of several ways.

For an example, not intended to be limiting in any way, there might be differing versions of the same media stream written to the same physical media. In one embodiment, this might occur if there is an English-language version and a French-language version of the same media stream. In one embodiment, this might occur if there is a “theater release” version and a “director's cut” version of the same media stream. In one embodiment, this might occur if there are multiple versions for different encodings, such as for example different aspect ratios (a 4:3 full screen version versus a 16:9 wide-screen version of the same media stream) or such as for example an NTSC version versus an HDTV version of the same media stream.

For an example, not intended to be limiting in any way, there might be additional material besides the basic media stream written to the same physical media. In one embodiment, this might include an introduction or a set of previews, a feature presentation, a set of credits, a set of out-takes, or a trailer for the feature presentation. In one embodiment, this might include a set of additional information about the characters, actors, or special effects, a set of video games, or a set of educational material.

For an example, not intended to be limiting in any way, there might be multiple media streams, each (either relatively closely or relatively remotely) associated with each other. In one embodiment, this might include a set of relatively short cartoon features, or other short media streams, which collectively fit onto a single DVD, or for example, not intended to be limiting in any way, a set of four Abbott and Costello full-length movies on a single double-sided DVD. In one embodiment, this might include a sequence of episodes of a television series, or other series, which have been collected for sale on a single DVD or a set of multiple DVDs.

However, this poses a problem in that a use of the DVD involves selecting a media stream for presentation. While it is possible to allow the user to select from the different media streams written onto the physical media (such as for example by the user interacting with menu items supplied with each physical media object), this has the drawbacks (1) of being at least somewhat cumbersome and of (2) possibly generating at least some confusion, each with the effect of possibly detracting from the viewing experience.

When DVDs are created, some media streams might be too large for a single item of physical media. This can occur in one of several ways.

For an example, not intended to be limiting in any way, a media stream representing a movie might run longer than can be written onto one side of a DVD. There are some DVDs in which data representing media streams is written so, with the effect that a single movie can be fitted onto a single physical DVD, but with the drawback that the movie is split into two portions, one for each side of the DVD.

For an example, not intended to be limiting in any way, a collection of media streams, such as a set of associated movies or a set of associated episodes of a television series, might be written onto multiple DVDs for sale as a set. The number of distinct media streams actually written onto each individual DVD (or side of a DVD) can vary widely in response to the size of those media streams (and the size of any additional information). In one embodiment, a collection of movies, such as a set of Oscar nominees for 2004, might be grouped into a set of multiple DVDs for sale as a set. In one embodiment, a collection of television episodes, either spanning a single season, or spanning an entire run of that television show, might be grouped into a set of multiple DVDs for sale as a set.

However, this poses several problems. First, presentation of a media stream involves selecting the DVDs associated with that media stream. Second, use of the set of multiple DVDs still involves selecting one of a relatively large number of media streams for presentation. Third, watching a single media stream that spans both sides of a DVD involves manually manipulating the DVD in the middle of the presentation (such as for example extracting the DVD, flipping it over, and reinserting it into the system), with the effect of breaking the flow of presentation. Similarly, watching a single media stream that spans more than one DVD involves physically manipulating both the first DVD and the second DVD. These problems present similar drawbacks to those described above.

Storing the contents of DVDs on a hard drive, or putting the DVDs in a carousel, partially solves this problem of requiring physical manipulations of DVDs. However, even those solutions have multiple drawbacks. (1) They do not solve the problem of having to manually interact with DVD menus on the individual DVDs. (2) In the event there are a relatively large number of DVDs to interact with, the user is still involved in physically manipulating them.

Accordingly, it would be advantageous to provide a technique for associating multiple media streams possibly found in multiple DVD packages with their dispositions within such packages. One advantageous effect would be to allow a user to conveniently and naturally select and view those media streams without knowing the disposition of those media streams within those packages.

### SUMMARY OF THE INVENTION

The invention provides a method and system capable of associating multiple media streams (such as for example, possibly found in packages containing more than one DVD), with their dispositions within such packages. In an aspect of the invention, a user can conveniently and naturally select, present, and resume presentation of, content chunks without the user needing to know the disposition of those content chunks within those packages.

In an aspect of the invention, the system associates content chunks, which may or may not be selectable, with media objects (including either physical media or otherwise stored digital content), and dispositions therein, without necessarily burdening the viewer with that association. In one embodiment, the system includes a database (the “content database”) maintaining those associations, that is, which content chunks are associated with which particular media objects, and their dispositions within those media objects, and which media objects are associated with (contain a part of) each particular content chunk. This content database might include information that associates multiple media objects with a particular content chunk, or information that associates one particular media object with multiple content chunks.

In one embodiment, each media object is associated with a unique media hash value, with the effect that the content database can be optimized by associating content chunks in part with media hash values (rather than actual media objects).

In one embodiment, the content database includes at least a portion that is constructed relatively remotely from a home entertainment system, which portion is cached or downloaded to the home entertainment system. This has the effect that the home entertainment system has a local content database with the appropriate content database information available when attempting to display, present, or resume presentation of, content chunks media objects. However, some alternative embodiments may differ.
It may be the case that at least a portion of the information associating content chunks with media objects (or media hash values), and dispositions therein, is included on or with the DVD itself.
It may be the case that at least a portion of the information in the local content database was generated or maintained locally (for example, for home movies or favorite scenes). In such alternative embodiments, at least a portion of the information in the content database, including at least some information associating content chunks with media objects (or media hash values), and their disposition therein, might be included with the local content database.

In an aspect of the invention, content chunks might be selectable by a viewer with the system detecting those selections and providing a resulting action, such as for example presentation (with the user interface) of further information, presentation of a content chunk, or resumption of presentation of a content chunk. For an example, not intended to be limiting in any way, a content chunk might be or include a feature-length movie. In one embodiment, a particular content chunk might or might not be independently selectable for presentation, and might also include other content chunks that may be or may not be also independently selectable for presentation. For an example, not intended to be limiting in any way, a content chunk might be or include one or more of the following.
As described herein, a content chunk might be or include a feature-length movie, a set of previews, a trailer for that movie, a set of “chapters” for that movie (with the effect that the viewer can skip to a selected bookmark in the movie), a set of credits, a set of out-takes or bonus scenes for that movie, a set of associated other material for that movie, a combination of some or all of the above, and the like. That associated other material might include promotional material such as posters or music videos, video games, a set of “behind the scenes” material, and the like. In one embodiment, this would have the effect that a content chunk might be or include a monolithic item for presentation, or might instead include many sub-content-chunks, which might fall into a tree structure, lattice structure, or other partial ordering, at least some of which are individually selectable for presentation.
Similarly, as described herein, a content chunk might be or include an entire season of a television series, an individual episode of that season, and the like.
Similarly, as described herein, a content chunk might be or include a set of presentable (favorite) scenes (such as film clips containing each of the famous lines in the movie “Casablanca”), possibly manufactured by an owner or distributor of the original content, possibly manufactured by the viewer using bookmarks or watchpoints (as described in the incorporated disclosure), or possibly manufactured by a third party (such as a distributor of horror movies manufacturing a compilation of all the fright scenes in Oscar-winning movies).
Similarly, as described herein, a content chunk might be or include multiple versions of a movie, likely to be alternative versions, such as multiple versions differing by sound track or video format or by widescreen versus pan-and-scan. Such multiple versions might also include a standard version and a “director's cut”.
Similarly, as described herein, a content chunk might be the content on a package of DVDs (or other physical media, or other downloadable content) sold as a unit.

In an aspect of the invention, a (selectable) content chunk might span more than one media object, without the viewer necessarily having any idea of that fact. Similarly, a (selectable) content chunk might switch back and forth among multiple media objects, again without the viewer necessarily having any idea of that fact. Selectable content chunks might also have associated user-accessible metadata with them: such as title, actors, directors, cover art, and the like.

In an aspect of the invention, a viewer may ask to see more detailed information about a particular selectable content chunk. This allows the viewer to see information about content chunks included within that particular selected content chunk.

In one embodiment, selectable content chunks included in the particular selected content chunk might be organized for the convenience of the user, such as for example for ease of manipulation involving a user interface.

In an aspect of the invention, multiple content chunks may be associated with each other, such as for example, grouped together in a set, to form a single content chunk that might be selected or manipulated by the user. For an example, not intended to be limiting in any way, substantially all of the content chunks associated with the media objects included in a DVD package are included within the content chunk associated with that whole DVD package. This has the effect that the viewer has a substantially more manageable number of choices within a menu of choices related to that DVD package, rather than the likely rather large number of choices that would be afforded if each and every possible content chunk were presented, with the user interface, at once as a selectable content chunk.

Another example might occur in the event that one or more DVDs include several related episodes (e.g., of a TV show). In such events, a single content chunk might contain such episodes ordered substantially sequentially without any need to navigate a DVD menu.

In one embodiment, this aspect of the invention includes at least some of the following capabilities provided to the viewer.
The term “selection” refers to those content chunks that are the primary unit of organization in the user interface. Thus a selection is a content chunk, which usually contains multiple other selectable content chunks. The viewer's user interface displays a set of elements that represent selections. These elements may by rows or icons, as described in the incorporated disclosure, particularly the following two patent applications.
U.S. Patent Application filed Apr. 18, 2003, titled “Grid-Like Guided User Interface for Video Selection and Display”, attorney docket number 217.1017.01.
U.S. Patent Application filed Apr. 18, 2003, titled “Mosaic-Like User Interface for Video Selection and Display”, attorney docket number 217.1018.01.

For an example, not intending to be limiting in any way, when a viewer selects a selection, the system might present that selection (or one of the sub-content chunks within that selection. For an example, not intended to be limiting in any way, when a viewer selects a selection, the user interface might present multiple elements of text or icon, as described in the incorporated disclosure, each such element of text or icon being associated with one or more selectable content chunks within the selection.
Typically, the number of selections in the system is substantially less than the number of individual (selectable) content chunks, as each selection likely contains at least three selectable content chunks (such as for example: a feature, a trailer, and the entire media object).
Selections might represent only certain selectable content chunks such as the collection of media streams associated with a particular “movie” or there could be selection in some or all views of the viewer user interface that represent individual content chunks associated with a movie.
Selections can represent individual episodes or movie clips, or collections of feature movies or sequences of film clips, or favorite scenes, episodes, songs, play-lists, or any other kind of content chunk.
A viewer may sort, search, and otherwise manage their collection by manipulating the attributes associated with each selection.
The terms “play”, “playback”, “present”, “presentation”, and the like, refer to presenting (sometimes herein referred to as “playback”) of a content chunk, with the effect that a viewer or listener might access the media stream represented by the digital data included in that content chunk. For an example, not intended to be limiting in any way, a feature length movie might be “played” or “presented”, as if in a theater. For an example, not intended to be limiting in any way, a concert or symphony might be “played” or “presented”, as if on a sound system. These terms are intended to be broad enough to include all manner of human sensation. The term “present” is sometimes used herein for data, icons, or other information presented through the user interface. In the event of that usage, the user interface is either explicitly mentioned, or it would be clear from context to those skilled in the art.
In one embodiment, for an example, not intended to be limiting in any way, the user can, for any selection, choose to view more detailed information about it. This causes the presentation, with the user interface, of enhanced metadata for the selection and allows the user to explicitly choose a specific content chunk within, or associated to, that selection, to present.
For an example, not intended to be limiting in any way, in the event that the selectable content chunk includes content chunks for episodes within the selectable content chunk, those content chunks for episodes might be grouped under an “episodes” sub-heading.
For an example, not intending to be limiting in any way, in the event that the selectable content chunk consists of a sequence of favorite scenes, asking for more detailed information might cause it to be broken down into individual selectable content chunks, each of which is a favorite scene.
For an example, not intending to be limiting in any way, in the event that the selectable content chunk corresponds to a package of multiple DVDs, when the user requests further information, the system might respond with the effect of causing the package to “expand” to a family of selectable content chunks, each corresponding to an individual DVD.

The display of this information may be affected by parental control restrictions. For example, under various circumstances, one might suppress display of information about some but not all content chunks within a content chunk.

In an aspect of the invention, a viewer might select a particular selectable content chunk and ask for it to be “played”. That is, the view might ask for a media stream appropriate to that selected content chunk to be presented.

This media stream to be presented may omit several minutes of advertisements that the viewer must watch when playing the corresponding DVD disc with a DVD player. The media stream to be presented may omit the need for any interaction by the viewer with the DVD menu.

In one embodiment, the system does what the viewer “really wants”. That is, the user may really want to see a preview of a large content chunk, such as for example, to see what it looks like, rather than immediately playing it.
In one embodiment, a viewer might be presented, through the user interface, with multiple ways of playing a selectable content chunk, such as to either to play all episodes or to play the first episode.
In one embodiment, the viewer might select a selectable content chunk containing multiple smaller content chunks. The system would then, without any further interaction with the viewer, “play it all” by presenting all those smaller content chunks in sequence, that is, “one touch presentation”.
In one embodiment, requesting play of a playable content chunk (that is, a content chunk capable of being presented to the user) such as a collection will use a play-list of clips from the content chunks within the collection. That is, playing this collection content chunk causes the presentation not of the concatenation of the content chunks in the collection, which could take days, but instead causes the presentation of the concatenation of certain much smaller content chunks, namely representative film clips, contained in the content chunks in the collection.

In such embodiments, the content database might define a content chunk substantially subsidiary to (such as substantially one included in, or included in a trailer related to) each large content chunk, so that playing that large content chunk, or a content chunk containing that large content chunk, would cause the presentation of the subsidiary content chunk in place of the content chunk itself. This might happen even though the subsidiary content chunk might be independently playable or selectable. With such a defined subsidiary to each content chunk, one could use search criteria to define a collection in real time, and request the playing of this collection; this would cause the presentation of the concatenated sequence of content chunks subsidiary to the content chunks in the collection. For an example, not intended to be limiting in any way, requesting the play of all John Wayne movies released before 1956 would have the effect of causing the presentation of a series of short representative clips from those movies. These subsidiary content chunks may be provided by the author of the DVD, for example as a trailer, or they may be constructed, like a favorite scene, using bookmarks and watchpoints by a third party or by the user. This has the effect that, by associating short film clips to larger individual content chunks, the system can naturally associate play-lists of clips to collections of larger content chunks.
In one embodiment, requesting the play of a content chunk corresponding to a physical package containing multiple DVDs might cause the first DVD to play or it might cause the presentation of feature presentation on the “first” DVD.
In one embodiment, requesting the play of a content chunk including multiple versions of a movie could cause either presentation of the user-preferred version or the offer of a choice.

The action taken by the system when the user requests the playing of a content chunk is designed to be that which the user “really wants”. For example, the user may really want to see a preview of the large content chunk, or what the large content chunk looks like, rather than really playing the whole thing. In general, the system interprets this by sometimes presenting default subsidiary content chunks rather than the content chunks themselves.

In an aspect of the invention, a viewer might select a particular selectable content chunk and ask for “play to be resumed”. When playback is stopped, resume information can be stored with some or all selectable content chunks that contain the just presented content chunk. In alternative embodiments, resume information may be stored only with the smallest selectable content chunk that contains the content chunk that was just presented.
This has the effect that the viewer might resume playback of the last viewed content chunk simply by selecting “resume playback” for a particular selectable content chunk that contains multiple content chunks, individually selectable or not, including the one last viewed. The viewer is not required to remember which content chunk they were last viewing.
This has the effect that, in the event that the last viewed content chunk was an episode, among many episodes within a larger selectable content chunk, and the viewer stopped playback while in the credits for that content chunk, the resume information for the larger content chunk can be set to lie in the next episode available in the larger selectable content chunk. Similarly, if the last viewed content chunk was one of a series of movies (or film clips), and the series of movies (or film clips) make up a larger selectable content chunk, and the viewer stopped playback while in the credits for that last viewed content chunk, the resume information for the larger selectable content chunk can be set to be at the start of the next movie (or film clip). In these cases, information as to an ordering of content chunks within a larger content chunk is recorded in the content database. Such an ordering might be for example according to the dates on which the content chunks were first released on television or at the cinema.
Determining the last-watched position in a content chunk such as a feature movie is relatively simple. However, it is more complicated for a content chunk such as a series of episodes. Default configuration and user preferences are used to determine where a series of episodes is resumed when, for example, the first episode has been watched, the second has not been watched, and five minutes of the third episode has been watched. This determination could be in response to user input, to detection of multiple viewers, to user preferences or profile, to staleness or the amount of time elapsed since previous views, to quantity watched and not watched.

In one aspect of the invention, one touch presentation of a given selectable content chunk (especially a selection) includes a technique with the effect that a most appropriate presentation option for that viewer is selected. In one embodiment, the following method is used.
In the event that that the selectable content chunk has resume information associated with it, the system resumes playback at the location specified in that resume information, within the content chunk associated with the resume information.
Otherwise, in the event that the selectable content chunk includes episode content chunks, the system begins presentation of all episodes in sequence.
Otherwise, in the event that the selectable content chunk includes feature presentation content chunks, the system selects the most appropriate such feature presentation content chunk for this viewer and presentation device (in response to at least one of: aspect ratio; parental control rating; resolution, that is, standard definition versus high definition) and begins presentation of that selected feature presentation content chunk.
Otherwise, in the event that the selectable content chunk includes trailer content chunks, the system selects the most appropriate trailer content chunk for this viewer and presentation device, in response to similar considerations, and begins presentation of that selected trailer content chunks.
Otherwise, in the event that the selectable content chunk includes a DVD disc content chunk, the system selects the first such content chunk and begins playback of that first such content chunk.
Otherwise, the system might determine, within the selectable content chunk, the “best,” that is, the most likely to be preferred, choice for the viewer, possibly in response to at least one of the following. (1) which multiple viewers, including possibly how many such multiple viewers, are in the range of the presentation device, (2) the location of the presentation device, (3) demographic or viewing preference information about the viewer(s), whether expressed explicitly or implicitly, (4) how long it has been since the viewer(s) presented or viewed that selectable content chunk, or smaller content chunks included in the selectable content chunk, if the viewer(s) interrupted presentation, and if so, for what reason the viewer(s) did so.

In an aspect of the invention, one touch presentation of a given selectable content chunk (especially a selection) includes a technique with the effect that a most appropriate presentation option for that viewer is selected. In one embodiment, the system selects the most appropriate of multiple versions of the same movie. For example, the system selects the most appropriate aspect ratio (e.g., 4:3 and 16:9), the most appropriate display resolution, the most appropriate parental control rating, the most appropriate audio track, and the most appropriate between a monochrome and colorized version.

After reading this application, those skilled in the art would recognize that the invention provides an enabling technology by which substantial advance is made in the art of user interfaces for media streams and digital content representative thereof.

For example, the invention might be used to provide one or more of, or some combination or extension or mixture of, any of the following.
In one embodiment, as described above, a viewer might manufacture their own content chunk having the property of spanning multiple media objects. This would have the effect that this new content chunk might be shared among viewers or among others with rights to present those portions of those media objects.
In one embodiment, a user interface available to a viewer might have differing techniques for presenting content chunks that include associated content chunks. For an example, not intended to be limiting in any way, the user might select a content chunk and in response be presented, through the user interface, with a set of associated selectable content chunks. This would have the effect that the user could select one of the associated content chunks at each level, until a monolithic selectable and presentable content chunk was available.
In one embodiment, the media objects remain on DVDs or other optical media and use of the invention would require a mega-changer for DVDs or other optical media or, from time to time, require the physical manipulation of DVDs or other optical DVDs.

### BRIEF DESCRIPTION OF THE DRAWINGS

FIG. 1 shows a block diagram of a system capable of associating multiple selectable content chunks possibly found in multiple DVD packages with their dispositions within such packages.

FIG. 2 shows a process flow diagram of a method of operating a system capable of associating multiple selectable content chunks possibly found in multiple DVD packages with their dispositions within such packages.

### INCORPORATED DISCLOSURE

This application incorporates by reference and claims priority of at least the following documents.
U.S. Provisional Patent Application 60/488,367, filed Jul. 15, 2003, attorney docket number 217.1019.01, titled “Bookmarks and Watchpoints for Selection and Presentation of Media Streams”.
U.S. patent application Ser. No. 10/655,496, filed Sep. 3, 2003, attorney docket number 217.1019.02, titled “Bookmarks and Watchpoints for Selection and Presentation of Media Streams”.
A technical appendix for U.S. Provisional Patent Application 60/488,367, filed Jul. 15, 2003, itself including a document titled “Automatic Masking”.

These documents are hereby incorporated by reference as if fully set forth herein, and are sometimes referred to herein as the “incorporated disclosure”. Inventions described herein can be used in combination or conjunction with technology described in the incorporated disclosure.

### DETAILED DESCRIPTION OF THE PREFERRED EMBODIMENT

In the description herein, a preferred embodiment of the invention is described, including preferred process steps and data structures. Those skilled in the art would realize, after perusal of this application, that embodiments of the invention might be implemented using a variety of other techniques not specifically described, without undue experimentation or further invention, and that such other techniques would be within the scope and spirit of the invention.

Definitions

The general meaning of each of these following terms is intended to be illustrative and in no way limiting.
The phrase “media stream”, and the like, describes information intended for presentation in a sequence, such as motion pictures including a sequence of frames or fields, or such as audio including a sequence of sounds. As used herein, the phrase “media stream” has a broader meaning than the standard meaning for “streaming media,” (of sound and pictures that are transmitted continuously using packets and that start to play before all of the content arrives). Rather, as described herein, there is no particular requirement that “media streams” must be delivered continuously. Also as described herein, media streams can refer to other information for presentation, such as for example animation or sound, as well as to still media, such as for example pictures or illustrations, and also to databases and other collections of information.
The phrase “digital content”, and the like, describes data in a digital format, intended to represent media streams or other information for presentation to an end viewer. “Digital content” is distinguished from packaging information, such as for example message header information. For the two phrases “digital content” and “media stream,” the former describes a selected encoding of the latter, while the latter describes a result of presenting any encoding thereof.
The phrase “digital media,” and the like, describes physical media capable of maintaining digital content in an accessible form. Digital media includes disk drives (including magnetic, optical, or magneto-optical disk drives), as well as any other physical media capable of maintaining information, such as digital content.
The term “DVD,” or digital versatile disc, and the like, is a technology standard that stores data on optical discs. Like the CD (compact disc) that came before it, a DVD holds its information in a digital format as bits denoting ones and zeros on the surface of the disc. A DVD is an example of a form of digital media.
The phrase “DVD package”, and the like, refers to a physical box, probably including at least one DVD. In typical cases, each DVD package has a unique UPC code, includes a single DVD, and on the DVD includes a single movie. However, in the context of the invention, there is no particular requirement for these typical cases. A DVD package might include more than one DVD, more than one movie, more than one version of a single movie, a set of movies, or a set of episodes of a television show. Alternatively, a set of more than one DVD packages might collectively include the same movie (if the movie is too long for a single DVD package), or might collectively include more than one movie, or more than one version of the same movie.
The term “bookmark”, and the like, describes a reference to a logical location selected within a media stream. In one embodiment, bookmarks are not necessarily preselected by the creator or distributor of that media stream, and are possibly dynamically selected by a recipient of digital content representing that media stream. In one embodiment, presentation devices are capable of starting or restarting presentation from a selected bookmark.
The terms “watchpoint”, and the like, describe a reference to a logical state of a presentation device, such as for example a logical location selected within a media stream. In one embodiment, watchpoints are capable of associating one or more events therewith, and (preferably) those one or more events might be conditioned on some other data or state information. For one example, the user might designate a bookmark at the beginning of a selected film clip, a watchpoint with the end of that same film clip, and an event associated with the watchpoint, which event directs a presentation device to return to a presentation state it was at before presenting from the bookmark. In this example, the film clip effectively acts as a media element capable of being inserted into another, different, media stream, without involving any other digital content associated with the larger media stream that contains that film clip.
The phrase “content server”, and the like, describes a device (or a portion thereof, or a set of such devices or portions thereof) capable of sending digital content to recipients. For example, a content server might include a web server at which a user is provided the capability of purchasing digital media for download. In the context of this application, there is no particular requirement that the server be (logically or physically) located at any particular address or place, or have any particular architecture, or use any particular protocol for communication. For example, the content server might include a process logically available to a local presentation device.
The phrase “media object”, and the like, refers to a file, or collection of files, maintained at a local or remote server or on an optical medium such as a DVD or on another digital medium, that holds digital content. In one embodiment, the file or collection of files is structured as it was on one side of a DVD or both sides of a DVD or other optical medium or other digital medium before being copied onto a local or remote server. In this embodiment, this has the effect that a single-sided DVD would usually be associated with a single media object, while a double-sided DVD would be associated with two (or possibly one) separate media objects. In one embodiment, the file or collection of files is structured as it was when downloaded from a remote content server. In one embodiment, each media object has an associated “media hash” value, computed in response to at least a portion of the digital content representing the media object. In one embodiment, each media hash value is maintained using a “content database” (at a remote server) and using a cached local content database.
The phrase “content chunk”, and the like, refers to a media stream from the “point of view” of the viewer. In the abstract, a content chunk is just a media stream. However, the viewer has access only to content contained on certain servers or media. So a content chunk is a media stream which is contained on those servers or media. A content chunk may be present as contiguous data on those servers or media or it may be present as a concatenation, or other assembly, of non-contiguous sets of contiguous data. This has the effect that a single media object might include more than one content chunk, or that a single content chunk might be distributed across more than one media object. The content chunks of interest in a particular system are those that can accessed in some sense by the viewer. For example, a feature presentation contained on a DVD disc is a content chunk. In one embodiment, a content chunk might include or be a feature, trailer, episode (of a series), credits, or some combination of any or all of the above, or the whole media object, and the like. In one embodiment, a content chunk might be a play-list: a linked collection of smaller content chunks such as film clips. The information defining a content chunk in the preferred embodiment is a sequence of bookmarks and watchpoints into one or more media objects. A content chunk is a simple object that is defined by such positional information, and not its relation to larger or smaller content chunks. Some content chunks may be associated with a selectable element in a user interface available to the viewer, such as those selectable elements described as part of the “guide” or “mosaic” user interfaces in the incorporated disclosure. Such a content chunk is called a “selectable content chunk”.
The phrases “control rules”, “parental control rules”, “presentation control rules”, and the like, refer to rules imposed by a controller of the local system (e.g., the home viewing system), that might restrict the ability of users (e.g., viewers) to obtain access (whether access to media streams, their metadata, or other information). For an example, not intended to be limiting in any way, one type of control 11 rule might include a password override to allow a viewer to see R-equivalent media streams.
The phrases “control effects”, “parental control effects”, “presentation control effects”, and the like, refer to rules imposed by an owner of content (e.g., a media stream or portion thereof), that take effect when one or more control rules is invoked, such as by refusing to present, editing, or otherwise acting upon otherwise accessible information. For an example, not intended to be limiting in any way, one type of control effect might include an alternative scene to present to those viewers not authorized to see R-equivalent media streams.
The phrases “control rating”, “parental control rating”, “presentation control rating”, and the like, refer to condensed descriptions of content, with the effect that a controller of the local system can broadly refer to information having such ratings. For an example not intended to be limiting in any way, one type of rating might be “R for graphic violence”, providing the controller of the local system with brief information to determine if content chunks with that rating are appropriate for children aged 5 or under.

The scope and spirit of the invention is not limited to any of these definitions, or to specific examples mentioned therein, but is intended to include the most general concepts embodied by these and other terms.

System Elements

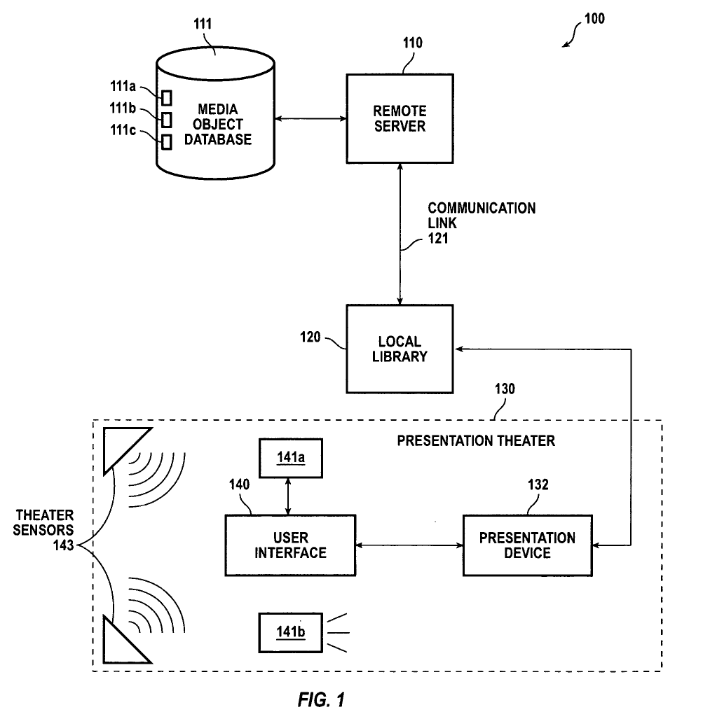

FIG. 1 shows a block diagram of a system capable of associating multiple media streams possibly found in packages containing multiple DVDs with their dispositions within such packages.

A system 100 includes elements as shown in FIG. 1, plus possibly other elements as described in the incorporated disclosure. These elements include at least a remote server 110, a local library 120, at least one presentation theater 130, and a user interface 140.

The remote server 110 includes elements as shown in FIG. 1, plus possibly other elements as described in the incorporated disclosure. These elements include at least a content database 111 and a communication link 112. In one embodiment, the remote server 110 includes at least a portion that is either physically, functionally, or logically remote from the local library 120. In one embodiment, the remote server 110 is capable of downloading digital content, as described in the incorporated disclosure, in a cryptographically secure manner, also as described in the incorporated disclosure.

The content database iii includes elements as shown in FIG. 1, plus possibly other elements as described in the incorporated disclosure. These elements include at least the following information.
information 111a describing media object hash values associated with content chunks (media object hash values are used in lieu of media objects, as the latter are typically rather large)
information 111b describing bookmarks and watchpoints associated with locations within media objects, and mapping content chunks to particular bookmarks and watchpoints
information ilic describing an “ordering” for content chunks, where “ordering” includes at least one of: (1) which content chunk is the “next” content chunk after each particular content chunk, and (2) which content chunks are included within, and thus, in some cases, selectable by a user within, each particular content chunk

The communication link 112 includes elements as shown in FIG. 1, plus possibly other elements as described in the incorporated disclosure. In one embodiment, the communication link 121 includes internet access. More generally, the communication link 112 might include any possible technique for communication, presently known or unknown.

The local library 120 includes elements as shown in FIG. 1, plus possibly other elements as described in the incorporated disclosure. These elements include at least a local cache 121 of information regarding media objects, and a local cache 122 of information regarding users, the latter including information 122a regarding user preferences and information 122b regarding a user history of presentations.

The at least one presentation theater includes elements as shown in FIG. 1, plus possibly other elements as described in the incorporated disclosure. Each presentation theater includes at least one presentation device 132.

The user interface 140 includes elements as shown in FIG. 1, plus possibly other elements as described in the incorporated disclosure. These elements include at least a control element 141 for use by the user, itself including at least one of a tablet 141a or a remote element 141b (either of which might be hand-held), a set of user accounts, and possibly a set of theater sensors 143, the latter including at least one of timing elements or user presence detectors.

Method of Operation

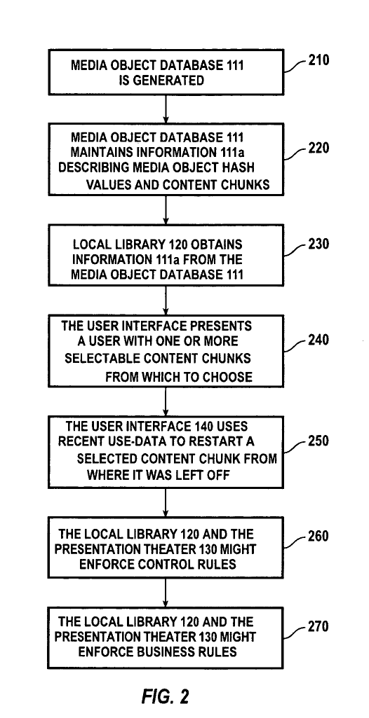

FIG. 2 shows a process flow diagram of a method of operating a system capable of associating multiple media streams possibly found in multiple DVD packages with their dispositions within such packages.

Although described serially, the flow points and method steps of the method 200 can be performed by separate elements in conjunction or in parallel, whether asynchronously or synchronously, in a pipelined manner, or otherwise. In the context of the invention, there is no particular requirement that the method must be performed in the same order in which this description lists flow points or method steps, except where explicitly so stated.

The method 200 includes steps as shown in FIG. 2, plus possibly other steps as described in the incorporated disclosure. These elements include at least a step 210 of generating the content database 111, a step 220 of associating content chunks with media objects (using their media hash values) and positional information within these media objects, a step 230 of locally caching this match and positional information, a step 240 of using match and positional information to present selected content chunks to a viewer, a step 250 of using recent use-data to resume a selected content chunk from where it was left off, a step 260 of coordinating with inventions as described in the incorporated disclosure (preferably including parental control), and a step 270 of using the techniques described herein as a method of doing business.

At a step 210, the content database 111 is generated. This might involve substantial effort, time, and human judgment, with the effect that the local library 120 receives the content database 111 as if given from “on high”.

At a step 220, the content database 111 maintains information 11a associating content chunks with media object hash values and positional information within media objects. In response to this information, the local library 120 determines which media objects are being referred to, and where within these media objects is the media stream being referred to, when a viewer selects a particular content chunk, without the viewer having to know what that association is.

At a step 230, the local library 120 obtains some or all of the the information 111a from the content database 111, and maintains or caches such a part of the information. This has the effect that the local library 120 is not involved in communication with the remote server 110 every time the previous step 220 is performed.

At a step 240, the user interface 140 presents a viewer with one or more selectable content chunks from which to choose. In preferred embodiments, the user interface 140 uses concepts from the “guide” and “mosaic”, as described in the incorporated disclosure. If and when the viewer selects a particular content chunk, the user interface 140 directs the presentation theater 130 to present one or more content chunks included in that selectable content chunk, as described below.

After reading this application, those skilled in the art will recognize that associating content chunks with media objects (for example, using their hash values) and positional information within these media objects (for example, using bookmarks and watchpoints), allows the user to select content chunks without having any knowledge of where those content chunks are stored within one or more media objects. This allows the user a relatively clean user interface, without any substantial involvement in determining which media objects are in fact used by those content chunks.

At a step 250, the user interface 140 uses recent use data to restart a media stream for a selected content chunk from where it was left off. In one embodiment, if the viewer leaves the presentation theater for a relatively short amount of time, the user interface 140 presents an option to “restart where left off”, even if the user was forgetful in hitting a pause button and allowed the presentation to continue in their absence. An amount of time considered “relatively short” for these purposes might be set by a controller of the local library 120, of the presentation theater 130, or by using the user interface 140 itself.

At a step 260, the local library 120 and the presentation theater 130 might enforce control rules as designated by a controller of the home entertainment system, and apply control effects as designated by an owner of the content to be presented, as described in the incorporated disclosure.

At a step 270, the local library 120 and the presentation theater 130 might enforce business rules as agreed to by a viewer of the home entertainment system and an owner of the content database 111a. For an example, not intended to be limiting in any way, the viewer and the owner might agree to give the viewer access to the content database 111a on agreed business terms. These terms might include (1) a subscription fee, (2) a fee for each use of the content database 111a, (3) a fee for each content chunk viewed involving use of the content database 111a, and the like.

Alternative Embodiments

Although preferred embodiments are disclosed herein, many variations are possible which remain within the concept, scope, and spirit of the invention. These variations would become clear to those skilled in the art after perusal of this application.
The invention is not restricted to presentation of movies, but is also applicable to other media streams, such as for example animation, as well as to still media, such as for example pictures or illustrations, and to presentation of databases and other collections of information, or of user interfaces associated with operating systems or application software.
The invention is not restricted to presentation of movies, but is also applicable to other circumstances where data to be used might be distributed among multiple media objects. For an example, not intended to be limiting in any way, a videogame to be played might include more than one module or level, each of which is separately purchasable on a separate DVD; the invention might be used to allow the user to play that videogame seamlessly without becoming involved in whether it was maintained on just one or a plurality of DVD's.

After reading this application, those skilled in the art will recognize that these alternative embodiments and variations are illustrative and are intended to be in no way limiting.

After reading this application, those skilled in the art would recognize that the techniques described herein provide an enabling technology, with the effect that heretofore advantageous features can be provided that heretofore were substantially infeasible.

### Technical Appendix

The set of inventive techniques are further described in the Technical Appendix. After reading this application and its Technical Appendix, those skilled in the art would recognize how to make and use the invention. All reasonable generalizations of techniques shown in this application and its Technical Appendix are within the scope and spirit of the invention, and would be workable, without further invention or undue experimentation.

At least the following documents are part of the technical appendix.
Packages Selections Play Items (MS Word document)
{include any screen shots or user manual pages relating to this invention}

The Technical Appendix is submitted with this application and hereby made a part of this application. The Technical Appendix, and all references cited therein, are hereby incorporated by reference as if fully set forth herein.

This Technical Appendix is intended to be explanatory and illustrative only, and not to limit the invention in any way, even if only a few (or only one) embodiment(s) are shown.

1. A method, including steps of
maintaining a database including information associating content chunks with media objects and positions therein, at least a portion of that database being located at a relatively remote server;
caching at least some of that information, at least a portion of a result of those steps of caching being maintained at a relatively local library;
receiving a selection of an element of a user interface representing at least one content chunk; and
taking an action at least partially in response to that selection and at least some cached information.

2. A method as in claim 1, wherein such media objects are the digital content once contained on a physical medium.

3. A method as in claim 2, wherein such physical medium is a package of optical discs sold as a unit.

4. A method as in claim 1, wherein such media objects are identified at least partially in response to a hash.

5. A method as in claim 1, wherein such media objects remain accessible from their original physical medium.

6. A method as in claim 1, wherein that information associating content chunks with media objects includes at least one of: (a) information relating more than one content chunk to the same media object, (b) information relating at least one content chunk to more than one media object.

7. A method as in claim 1, wherein at least some of that information is cached substantially locally.

8. A method as in claim 1, wherein at least one content chunk includes at least one of: a feature presentation, a set of “behind the scenes” material, a set of credits, a set of out-takes, a trailer, a video game, one or more previews, a set of promotional material, an episode of a television series, a substantially entire season of a television series.

9. A method as in claim 1, wherein at least one content chunk includes at least one of: a play-list of songs, favorite scenes, trailers, sports plays, film clips, or loops thereof.

10. A method as in claim 1, wherein at least one content chunk includes a collection of media streams, that collection being generated dynamically.

11. A method as in claim 1, wherein that information offers a user the capability of selecting one or more content chunks included within the one content chunk.

12. A method as in claim 1, wherein wherein that database includes information specifying at least one action to be taken upon receiving a request from a user.

13. A method as in claim 12, wherein that action includes at least one of (a) presenting a content chunk, (b) resuming presentation of a content chunk.

14. A method as in claim 12, wherein that action includes an indication of at least a portion of a media stream to be presented upon request.

15. A method as in claim 14, wherein that indication includes a set of bookmarks and a set of watchpoints.

16. A method as in claim 14, wherein that indication includes
a selection of a plurality of content chunks, each of that plurality being relatively small compared to a relatively larger content chunk in which it is included or representative of; and
a sequence of at least some of that plurality of content chunks being substantially representative of a relatively larger sequence of the relatively larger content chunks in which they are included or representative of.

17. A method as in claim 16, wherein
those relatively smaller content chunks include scenes from or trailers for feature movies; and
those relatively larger content chunks include feature movies or substantial fractions of the episodes of a television season.

18. A method as in claim 1, wherein that action is responsive at least in part to detectible conditions other than that selection and that cached information.

19. A method as in claim 18, wherein that action includes at least one of: refusal to present the content chunk, presentation of an alternative content chunk, requesting a key or password override before presenting the content chunk, determining to play the feature presentation when a request is made to play a content chunk containing both the feature presentation and other materials.

20. A method as in claim 18, wherein those detectible conditions include at least one of: parental control, presence of an alternative content chunk for presentation, active detection of presence of particular viewers, passive detection of presence of particular viewers, user preferences set at a substantially remote place or time.

21. A method as in claim 1, wherein that action includes displaying further information about that content chunk.

22. A method as in claim 1, wherein
that action includes at least one of: presentation or resuming presentation of a media stream associated with that content chunk;
that content chunk includes at least some of the content on a DVD; and
that media stream is substantially similar to at least one of (a) playing that DVD, (b) playing a feature presentation from that DVD.

23. A method, including steps of
associating a set of content chunks with a set of digital content, the digital content either being maintained on a set of physical media or having been copied from one or more physical media;
detecting a preference by a user for one or more of those content chunks; and
performing an action discernable to that user in response to those steps of detecting.

24. A method as in claim 23, wherein at least one of those content chunks includes at least one of: a portion of a media stream, a set of “behind the scenes” material, a set of credits, a set of out-takes, a set of promotional material, a trailer, a video game, one or more previews.

25. A method as in claim 23, wherein at least one of those content chunks includes at least one of: a feature presentation, a movie, a set of movies, an animated cartoon, an episode of a television series, at least a portion of a season of a television series.

26. A method as in claim 23, wherein at least one of those content chunks includes at least one media stream having more than one part, a plurality of those parts having been copied from an input medium.

27. A method as in claim 26, wherein a plurality of those parts are copied from a corresponding plurality of sides of DVD physical media.

28. A method as in claim 26, wherein a plurality of those parts are copied from a corresponding plurality of physical media input in a substantially unified grouping.

29. A method as in claim 23, wherein those steps of associating include
maintaining information about those content chunks; and
where to access their associated digital content.

30. A method as in claim 29, wherein that information is located at least in part at a substantially remote server.

31. A method as in claim 29, wherein those steps of associating include caching at least a portion of a set of information.

32. A method as in claim 29, wherein those steps of associating include maintaining a set of hash values.

33. A method as in claim 29, wherein those steps of associating include maintaining at least a portion of a database.

34. A method as in claim 29, wherein those steps of associating includes at least one of: a many-to-one relationship, a many-to-many relationship, a one-to-many relationship.

35. A method as in claim 29, wherein those steps of detecting are responsive to a user interface.

36. A method as in claim 35, wherein that user interface includes a grid user interface.

37. A method as in claim 35, wherein that user interface includes a mosaic user interface.

38. A method as in claim 29, wherein those steps of detecting are responsive to information regarding a recent set of presented content chunks.

39. A method as in claim 29, wherein those steps of detecting include
presenting a set of selectable elements, each associated with at least one set of content chunks;
receiving an indication of one or more of those selectable elements;
if that indicated selectable element includes a presentable content chunk, presenting that content chunk; and
if that indicated selectable element includes more than one included content chunk, detecting a preference by that user for at least one of the at least one included content chunk.

40. A method as in claim 29, wherein those steps of performing include at least one of: (a) presenting a first content chunk in a sequence, or (b) presenting a next content chunk in a sequence.

41. A method, including steps of
associating a set of content chunks with a set of digital content, the digital content either being maintained on a set of physical media or having been copied from one or more physical media;
conducting or completing a business relationship between a user and an owner of one of those content chunks.

42. A method as in claim 41, wherein at least one of those content chunks includes at least one of: a portion of a media stream, a set of “behind the scenes” material, a set of credits, a set of out-takes, a set of promotional material, a trailer, a video game, one or more previews.

43. A method as in claim 41, wherein at least one of those content chunks includes at least one of: a feature presentation, a movie, a set of movies, an animated cartoon, an episode of a television series, at least a portion of a season of a television series.

44. A method as in claim 41, wherein at least one of those content chunks includes at least one media stream having more than one part, a plurality of those parts having been copied from an input medium.

45. A method as in claim 44, wherein a plurality of those parts are copied from a corresponding plurality of sides of DVD physical media.

46. A method as in claim 44, wherein a plurality of those parts are copied from a corresponding plurality of physical media input in a substantially unified grouping.

47. A method as in claim 41, wherein those steps of associating include
maintaining information about those content chunks; and
where to access their associated digital content.

48. A method as in claim 47, wherein that information is located at least in part at a substantially remote server.

49. A method as in claim 47, wherein those steps of associating include caching at least a portion of a set of information.

50. A method as in claim 47, wherein those steps of associating include maintaining a set of hash values.

51. A method as in claim 47, wherein those steps of associating include maintaining at least a portion of a database.

52. A method as in claim 47, wherein those steps of associating includes at least one of: a many-to-one relationship, a many-to-many relationship, a one-to-many relationship.

53. A method as in claim 41, including steps of detecting a preference by a user for one or more of those content chunks.

54. A method as in claim 53, wherein those steps of detecting are responsive to a user interface.

55. A method as in claim 54, wherein that user interface includes a grid user interface.

56. A method as in claim 54, wherein that user interface includes a mosaic user interface.

57. A method as in claim 53, wherein those steps of detecting are responsive to information regarding a recent set of presented content chunks.

58. A method as in claim 53, wherein those steps of detecting include
presenting a set of selectable elements, each associated with at least one set of content chunks;
receiving an indication of one or more of those selectable elements;
if that indicated selectable element includes a presentable content chunk, presenting that content chunk; and
if that indicated selectable element includes more than one included content chunk, detecting a preference by that user for at least one of the at least one included content chunk.

59. A system including
information associating a set of content chunks with a set of digital content elements, at least one of the content chunks spanning more than one physical medium, or at least one of the digital content elements spanning more than one physical medium; and
instructions capable of interpretation to present at least one of the content chunks in response to a user preference of one of the digital content elements.

60. A system as in claim 59, wherein at least one of those content chunks includes at least one of: a portion of a media stream, a set of “behind the scenes” material, a set of credits, a set of out-takes, a set of promotional material, a trailer, a video game, one or more previews.

61. A system as in claim 59, wherein at least one of those content chunks includes at least one of: a feature presentation, a movie, a set of movies, an animated cartoon, an episode of a television series, at least a portion of a season of a television series.

62. A system as in claim 59, wherein at least one of those content chunks includes at least one media stream having more than one part, a plurality of those parts having been copied from an input medium.

63. A system as in claim 62, wherein a plurality of those parts are copied from a corresponding plurality of sides of DVD physical media.

64. A system as in claim 62, wherein a plurality of those parts are copied from a corresponding plurality of physical media input in a substantially unified grouping.

65. A system as in claim 59, wherein that information includes (a) information about those content chunks, and (b) where to access their associated digital content.

66. A system as in claim 65, wherein that information includes a set of hash values.

67. A system as in claim 65, wherein that information includes at least one of (a) one or more bookmarks, (b) one or more watchpoints.

68. A system as in claim 65, wherein that information is located at least in part at a substantially remote server.

69. A system as in claim 65, wherein that information is located at least in part in a cache.

70. A system as in claim 65, wherein that information is located at least in part in a portion of a database.

71. A system as in claim 59, wherein at least one of the digital content elements includes more than one content chunk.

72. A system including
a set of data representative of content chunks; and
information associating that set of data with a set of digital content, the digital content being (a) maintained on a set of physical media, or (b) having being copied from one or more physical media.

73. A system as in claim 72, wherein at least one of those content chunks includes at least one of: a portion of a media stream, a set of “behind the scenes” material, a set of credits, a set of out-takes, a set of promotional material, a trailer, a video game, one or more previews.

74. A system as in claim 72, wherein at least one of those content chunks includes at least one of: a feature presentation, a movie, a set of movies, an animated cartoon, an episode of a television series, at least a portion of a season of a television series.

75. A system as in claim 72, wherein at least one of those content chunks includes at least one media stream having more than one part, a plurality of those parts having been copied from an input medium.

76. A system as in claim 75, wherein a plurality of those parts are copied from a corresponding plurality of sides of DVD physical media.

77. A system as in claim 75, wherein a plurality of those parts are copied from a corresponding plurality of physical media input in a substantially unified grouping.

78. A system as in claim 72, wherein that information includes (a) information about those content chunks, and (b) where to access their associated digital content.

79. A system as in claim 78, wherein that information includes a set of hash values.

80. A system as in claim 78, wherein that information includes at least one of (a) one or more bookmarks, (b) one or more watchpoints.

81. A system as in claim 78, wherein that information is located at least in part at a substantially remote server.

82. A system as in claim 78, wherein that information is located at least in part in a cache.

83. A system as in claim 78, wherein that information is located at least in part in a portion of a database.

84. A system as in claim 72, including a signal indicative of a preference by a user for at least one of those content chunks.

85. A system as in claim 84, wherein that signal is responsive to a user interface.

86. A system as in claim 84, wherein that signal includes (a) a result of presenting a set of selectable elements, each associated with at least one set of content chunks, and (b) a result of receiving an indication of one or more of those selectable elements.

87. A system as in claim 84, wherein that signal is responsive to information regarding a recent set of presented content chunks.

88. A system as in claim 72, including a signal responsive to that preference, representing at least one of (a) a first content chunk in a sequence, (b) a next content chunk in a sequence.
